(19) United States
(12) Patent Application Publication
(10) Pub. No.: US 2005/0213480 A1
(43) Pub. Date: Sep. 29, 2005

(54) Optical disk with multilayered structure and method for identifying recording layer of the optical disk

(75) Inventors: Nobuki Yamaoka, Koufu-shi (JP); Toshihiko Takishita, Koufu-shi (JP); Seiro Oshima, Koufu-shi (JP); Atsushi Kondo, Koufu-shi (JP); Masataka Yamaguchi, Koufu-shi (JP); Takao Tagiri, Koufu-shi (JP)

Correspondence Address: MORGAN LEWIS & BOCKIUS LLP, 1111 PENNSYLVANIA AVENUE NW, WASHINGTON, DC, 20004, US

(73) Assignee: PIONEER CORPORATION

(21) Appl. No.: 11/085,130

(22) Filed: Mar. 22, 2005

(30) Foreign Application Priority Data
Mar. 25, 2004 (JP) P2004-88339

(51) Int. Cl. G11B 7/24

(52) U.S. Cl. 369/275.3

(57) ABSTRACT

An optical disk with multi-layered structure provided with at least two recording layers is provided. In respective recording layers, tracks are formed, and the track is formed such that the amount of eccentricity is different in respective recording layers. In the method for identifying the recording layer which identifies the recording layer of the optical disk, the recording layer is identified by detecting the amount of the eccentricity set to the track of the respective recording layers.

### BACKGROUND OF THE INVENTION

1. Field of the Invention

The present invention relates to an optical disk with multi-layered structure and a method for identifying recording layer of the optical disk, and more particularly to the optical disk with the multilayered structure provided with at least two recording layers and the method for identifying recording layer of the optical disk.

2. Description of Related Art

At present, in order to achieve increasing the capacity of an optical disk, there is proposed an optical disk in which two recording layers are laminated. In this kind of optical disk, on the occasion of recording and reproducing of information, it is necessary to set various kinds of parameters such as power of a light beam used for the recording and reproducing in accordance with each recording layer, thereby, it becomes necessary to identify each recording layer. Thus, the first recording layer and the second recording layer of the optical disk are provided with an identifying format each to identify the first recording layer and the second recording layer. By reading this identifying format, it is identified whether the recording layer is the first recording layer or the second recording layer. In this kind of method for identifying recording layer, since the identifying format provided on the recording layer is read, identification of the recording layer takes much time.

As the prior art, there is the method for identifying recording layer of the optical disk described in the Japanese Patent Application Laid-Open No. 2002-279647.

In the method for identifying recording layer of the Japanese Patent Application Laid-Open No. 2002-279647, as the two recording layers of the optical disk, there are formed the first layer track and the second layer track. The first layer track and the second layer track are wobbled. On the way the phase of the wobble is changed, and changing amount of the phase is set in such a way as to be different in each recording layer. Consequently, it is possible to identify whether the track of the recording layer is the first layer track or the second layer track by detecting the phase changing amount of the wobble applied to the track of the each recording layer.

In the method for identifying recording layer described in the Japanese Patent Application Laid-Open No. 2002-279647, when detecting the phase changing amount of the wobble applied to the track of the each recording layer, it is necessary to detect the wobbling signal while closing focus and tracking on the recording surface, thus there is a problem of taking much time in identification of the recording layer.

### SUMMARY OF THE INVENTION

The above-described problem is exemplified as the problem to be solved by the present application.

The invention according to claim 1 relates to an optical disk with multi-layered structure provided with at least two recording layers, in which a track is formed in each recording layer;
wherein the said track is formed in such a way that the recording layer has different amount of eccentricity of said track from each other.

The invention according to claim 2 relates to an optical disk with multi-layered structure provided with at least two recording layers, in which a track is formed in each recording layer;
wherein in that said track is formed in such a way that amplitude of a push-pull signal, which is obtained based on a reflected light from the track, differs in each recording layer.

The invention according to claim 3 relates to an optical disk with multi-layered structure provided with at least two recording layers, in which a groove is formed in each recording layer and said groove is wobbled in radial direction with predetermined cycle;
wherein said groove is in a state where a high frequency signal with shorter cycle than said predetermined cycle is superimposed and wobbled, and said cycle of the high frequency signal superimposed is different from each other in each recording layer.

The invention according to claim 4 relates to a method for identifying recording layer, which identifies a recording layer of an optical disk with multi-layered structure provided with at least two recording layers, in which a track is formed in each recording layer; wherein the said track is formed in such a way that the recording layer has different amount of eccentricity of said track from each other,
said method identifying the recording layer by detecting an amount of eccentricity set to a track of said each recording layer.

The invention according to claim 5 relates to a method for identifying recording layer, which identifies an optical disk with multi-layered structure provided with at least two recording layers, in which a track is formed in each recording layer; wherein said track is formed in such a way that amplitude of a push-pull signal, which is obtained based on a reflected light from the track, differs in each recording layer,
said method identifying the recording layer by detecting amplitude of a push-pull signal obtained on the basis of a reflected light from a track of said each recording layer.

The invention according to claim 6 relates to a method for identifying recording layer, which identifies an optical disk with multi-layered structure provided with at least two recording layers, in which a groove is formed in each recording layer and said groove is wobbled in radial direction with predetermined cycle; wherein said groove is in a state where a high frequency signal with shorter cycle than said predetermined cycle is superimposed and wobbled, and said cycle of the high frequency signal superimposed is different from each other in each recording layer,
said method identifying the recording layer by detecting a high frequency signal superimposed on a wobble of a groove of said each recording layer.

### BRIEF DESCRIPTION OF THE DRAWINGS

FIG. 1 is a view showing an apparatus to realize the method for identifying recording layer of an optical disk according to a first embodiment of the present invention;

FIGS. 2A to 2C are views showing a radial direction cross-sectional structure of the optical disk and a reflected signal from the optical disk according to a first embodiment of the present invention;

FIG. 3 is a view showing an apparatus to realize the method for identifying optical disk recording layer according to a second embodiment of the present invention;

FIGS. 4A, 4B are views showing a radial direction cross-sectional structure of the first recording layer in two-layered structure optical disk and a reflected signal from the first recording layer of the optical disk according to a second embodiment of the present invention; and

FIG. 5 is a view showing an apparatus to realize the method for identifying recording layer of optical disk according to a third embodiment of the present invention.

### DESCRIPTION OF THE PREFERRED EMBODIMENTS

Next, the preferred embodiment to execute the present invention will be described based on the accompanied drawings.

### (1) First Embodiment

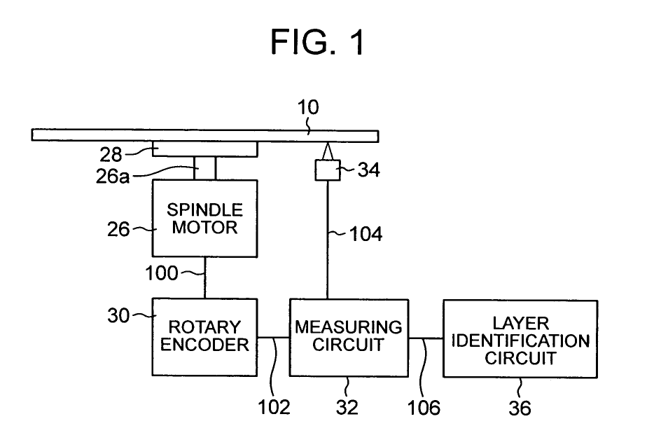

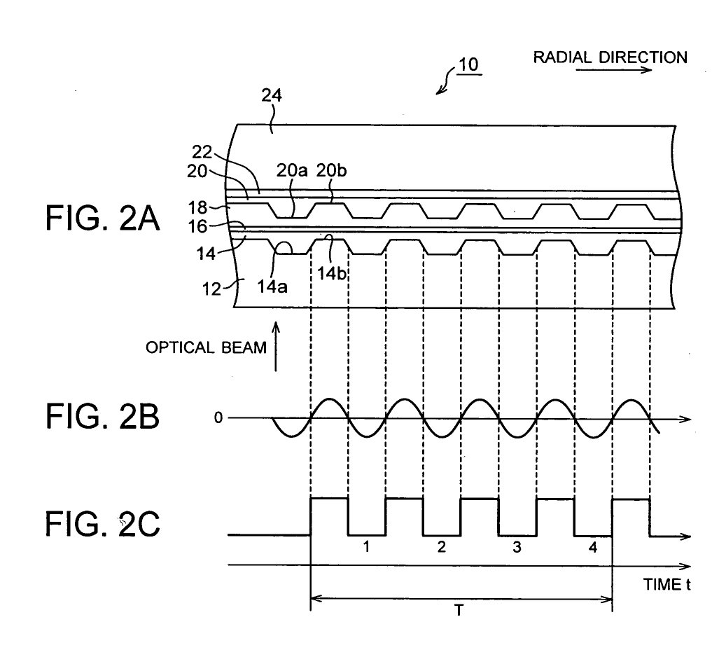

There will be described the first embodiment according to the present invention using FIG. 1 and FIG. 2. In the first embodiment, the two recording layers are formed in the optical disk. A groove to constitute a track is formed on each recording layer. The groove is formed such that the amount of eccentricity is different in each recording layer. The recording layer is identified by detecting the amount of eccentricity set to the groove of the each recording layer. Hereinafter, there will be described the first embodiment in detail.

FIG. 1 shows an apparatus realizing a method for identifying optical disk recording layer according to the first embodiment of the present invention. FIG. 2 shows a radial direction cross-sectional structure of the optical disk and a reflected signal from the optical disk according to the first embodiment of the present invention.

FIG. 2A shows a radial direction cross-sectional structure of the optical disk. In FIG. 2A, the optical disk 10 includes a substrate 12. The substrate 12 is provided with a first recording layer 14 and a first reflective layer 16. The first recording layer 14 and the first reflective layer 16 are provided with a second recording layer 20 and a second reflective layer 22 through an intermediate layer 18, and the second recording layer 20 and the second reflective layer 22 are provided with a protective layer 24. It should be noted that a groove part 14a and a land part 14b are formed on the first recording layer 14, and similarly, a groove part 20a and a land part 20b are formed on the second recording layer 20.

FIG. 2B shows a radial direction signal waveform obtained from a reflected light beam when making irradiation of a light beam from substrate 12 side in FIG. 2A, that is, a signal waveform of indicating that the light beam traverses the track. The signal becomes minimum at middle of the groove part 14a of the first recording layer 14, while the signal becomes maximum at middle of the land part 14b of the first recording layer 14. FIG. 2C shows a signal waveform after the signal waveform of FIG. 2B is subjected to waveform shaping with zero level as the basis.

The groove part 14a of the first recording layer 14 is eccentric, the optical beam traverses the track during one revolution of the optical disk 10. In FIG. 2C, a count value (the number of the track subjected to traverse) 4 during one revolution T of the optical disk 10 is obtained.
Consequently, the amount of eccentricity=(track pitch)×(count value namely the number of track after traverse)/(one revolution) equation (1)

Similarly, the groove part 20a of the second recording layer 20 is eccentric, and the light beam traverses the track during one revolution of the optical disk 10. Here, the optical disk is formed in such a way that the amount of eccentricity of the groove part 20a of the second recording layer 20 differs from the amount of eccentricity of the groove part 14a of the first recording layer 14. The amount of eccentricity of the groove part 14a of the first recording layer 14 is set to, for example, 0 to 25 μm, while the amount of eccentricity of the groove part 20a of the second recording layer 20 is set to, for example, 35 to 60 μm, and there is set a boundary area of, for instance, degree of 10 μm between 0 to 25 μm of the amount of eccentricity of the groove part 14a and 35 to 60 μm of the amount of eccentricity of the groove part 20a. It should be noted that 0 to 25 μm of the amount of eccentricity of the groove part 14a, 35 to 60 μm of the amount of eccentricity of the groove part 20a, and 10 μm of the boundary area are one example, and they are not limited to these values.

According to the optical disk constituted above, it is possible to identify the recording layers 14, and 20 by detecting the amount of eccentricity set to the groove parts 14a, and 20a of the respective recording layers 14, and 20. In the first embodiment, even if a tracking servo loop of the light beam is open, in case where a focus servo loop is close, it is possible to identify the recording layer, and it is possible to identify the recording layer easily and quickly.

Next, referring to FIG. 1, there will be described an apparatus to realize a method for identifying optical disk recording layer according to the first embodiment.

In FIG. 1, a driving shaft 26a of a spindle motor 26 is provided with a turn table 28, and an optical disk 10 which is shown in FIG. 2A is set on the turn table 28. A revolution signal 100 from the spindle motor 26 is supplied to a rotary encoder 30, and the rotary encoder 30 supplies one revolution signal 102 on the occasion of one revolution of the optical disk 10 to a measuring circuit 32. On the other hand, an optical pickup 34 is disposed under the optical disk 10. The optical pickup 34 makes irradiation of light beam to the optical disk 10. The optical pickup 34 detects a reflected light beam from the optical disk 10 to supply a tracking error signal 104 to the measuring circuit 32. The measuring circuit 32 counts the number of the track, which the light beam traverses, during one revolution of the optical disk 10 based on the one revolution signal 102 and the tracking error signal 104, and supplies a count value signal 106 of the number of the track to a layer identification circuit 36. The layer identification circuit 36 determines the amount of eccentricity using the equation (1) on the basis of a supplied count value signal 106. The respective groove parts 14a, 20a of the recording layers 14, 20 have the different amount of eccentricity from each other, therefore, it is possible to identify the recording layers 14, 20 based on the amount of eccentricity.

### (II) Second Embodiment

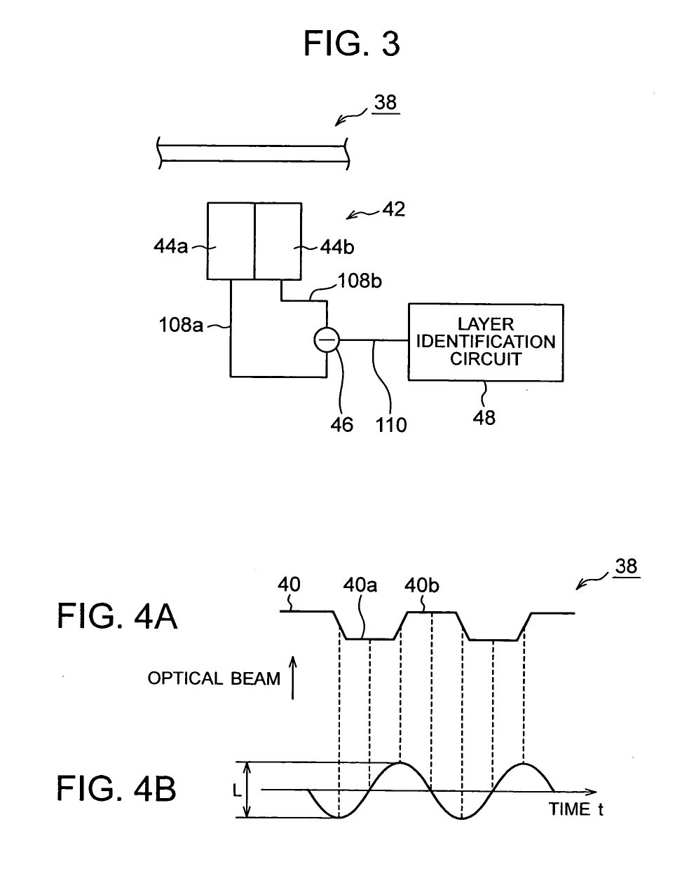

Next, there will be described the second embodiment which is another embodiment of the present invention using FIG. 3 and FIG. 4. It should be noted that, in the second embodiment, two recording layers are formed in the optical disk. In the respective recording layers, the groove constituting the track is formed. The groove is formed in such a way that the amplitude of a push-pull signal obtained based on reflected light from the groove differs in each recording layer. The recording layer is identified by detecting the amplitude of the push-pull signal obtained based on the reflected light from the groove of the each recording layer. There will be described the second embodiment in detail below.

In FIG. 3, there is shown an apparatus to realize the method for identifying optical disk recording layer according to the second embodiment of the present invention. In FIG. 4, shown is radial direction cross-sectional structure of the first recording layer in the optical disk of two-layered structure according to the second embodiment and the reflected signal from the first recording layer of the optical disk.

FIG. 4A shows radial direction cross-sectional structure of the first recording layer in the optical disk of two-layered structure. In FIG. 4A, there are formed are the groove part 40a and the land part 40b on the first recording layer 40 of the optical disk 38. Although it is not shown in FIG. 4A, the groove part and the land part are also formed on the second recording layer.

FIG. 4B shows a waveform of the push-pull signal (that is, a tracking error signal) obtained based on the reflected light from the groove of the first recording layer in the optical disk of two-layered structure shown in FIG. 4A. In the waveform of FIG. 4B, a sign L indicates the amplitude of the push-pull signal.

The aforementioned push-pull signal is described below. the amplitude of the push-pull signal becomes maximum in a state where phase depth of the groove part is λ/8 (λ: wave length of recording and reproducing beam), while the amplitude of the push-pull signal becomes zero in a state where phase depth of the groove part is λ/4. Consequently, it is possible to identify the first recording layer and the second recording layer based on the amplitude of the push-pull signal by setting the phase depth of the groove part of the first recording layer and the second recording layer so as to be different between λ/8 and λ/4. As one example, by setting the phase pitch of the groove part of the first recording layer, for instance, to λ/7 and setting the phase pitch of the groove part of the second recording layer, for instance, to λ/6, it is possible to identify the first recording layer and the second recording layer based on the amplitude of the push-pull signal. It should be noted that the phase depth λ/7 of the groove part of the first recording layer and the phase depth λ/6 of the groove part of the second recording layer are one example; they are not limited to these values.

According to the optical disk constituted above, it is possible to identify the first recording layer and the second recording layer by detecting the amplitude of the push-pull signal obtained based on the reflected light from the groove of the first recording layer and the second recording layer. In the second embodiment, even if a tracking servo loop of the light beam is open, in case where a focus servo loop is close, it is possible to identify the recording layer, and it is possible to identify the recording layer easily and quickly.

Next, there will be described an apparatus to realize the method for identifying optical disk recording layer according to the second embodiment while referring to FIG. 3.

In FIG. 3, an optical pickup 42 is disposed below the optical disk 38, and the optical pickup 42 includes bisecting detectors 44a, 44b. The optical pickup 42 makes irradiation of the optical beam to the optical disk 38, and optical pickup 42 detects the reflected light beam from the optical disk 38 with the bisecting detectors 44a, 44b. Detected signals 108a, 108b from the bisecting detectors 44a, 44b are supplied to a difference operating circuit 46, and the push-pull signal 110 is formed. The push-pull signal 110 is supplied to a layer identifying circuit 48. The layer identifying circuit 48 is capable of identifying the recording layer based on the amplitude of the push-pull signal 110.

It should be noted that the first embodiment and the second embodiment are applied to the optical disk which is capable of performing the recording and reproducing, however, it is possible to apply to a read only optical disk.

### (III) Third Embodiment

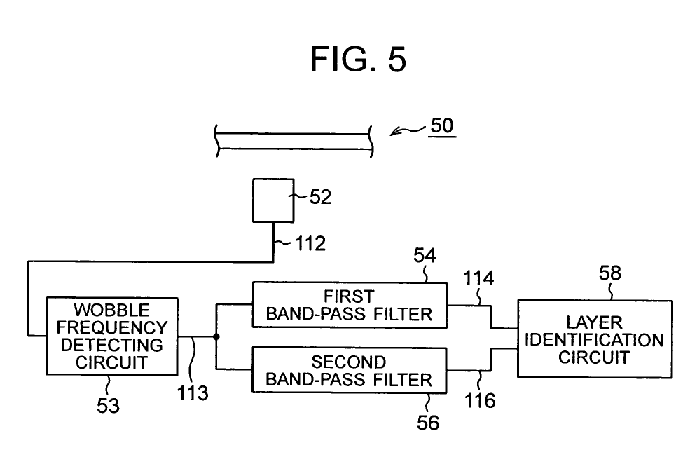

Next, there will be described the third embodiment which is still another embodiment of the present invention using FIG. 5. In the third embodiment, it should be noted that the two recording layers are formed in the optical disk, the groove constituting the track is formed at each recording layer, and the groove is subjected to wobbling in the radial direction with predetermined cycle. As for the frequency of the predetermined wobbling cycle, for instance, it is 140 kHz. Here the groove is under the condition where the high frequency signal with shorter cycle than the predetermined cycle is superimposed and wobbled. The superimposed cycle of the high frequency signal is set so as to be different in each recording layer. For instance, 300 kHz of the high frequency signal is superimposed and wobbled onto the groove of the first recording layer and 500 kHz of the high frequency signal is superimposed and wobbled onto the groove of the second recording layer. Consequently, it is possible to identify the recording layer by detecting the high frequency signal superimposed onto the wobble of the groove of each recording layer. It should be noted that 300 kHz and 500 kHz of the high frequency signal superimposed are set sufficiently apart from the frequency 140 kHz of the predetermined wobble cycle. In addition, the frequency 140 kHz of the predetermined wobble cycle, and the frequencies 300 kHz and 500 kHz of the high frequency signal superimposed are one example, and they are not limited to these values.

FIG. 5 shows an apparatus to realize the method for identifying optical disk recording layer according to the third embodiment of the present invention.

In FIG. 5, an optical pickup 52 is disposed below an optical disk 50, the optical pickup 52 irradiates the optical beam to the optical disk 50, and outputs a detection signal 112 based on the reflected light beam. The detection signal 112 is supplied to a wobble frequency detecting circuit 53, and the wobble frequency of the groove of the recording layer is detected. The wobble frequency signal 113 from the detecting circuit 53 is supplied to the first band-pass filter 54 and the second band-pass filter 56. In the example described above, the frequencies of the first band-pass filter 54 and the second band-pass filter 56 are set to 300 kHz and 500 kHz respectively. The signals 114, 116 from the first band-pass filter 54 and the second band-pass filter 56 are supplied to a layer identifying circuit 58. Consequently, the layer identifying circuit 58 is capable of identifying the recording layer based on whether the signal is output from the first band-pass filter 54 or the second band-pass filter 56.

It should be noted that, in the third embodiment, when identifying the recording layer, it is necessary to close both the tracking servo loop and the focus servo loop of the light beam. However, in the method for identifying recording layer of the above described Japanese Patent Application Laid-Open No. 2002-279647, it is identified whether the track of the recording layer is the first layer track or the second layer track by detecting phase changing amount of the wobble applied to the track of the each recording layer. The third embodiment has the superiority as compared with the method for identifying recording layer of the Japanese Patent Application Laid-Open No. 2002-279647 in that the third embodiment does not take much time in the identification.

It should be understood that various alternatives to the embodiment of the invention described herein may be employed in practicing the invention. Thus, it is intended that the following claims define the scope of the invention and that methods and structures within the scope of these claims and their equivalents be covered thereby.

The entire disclosure of Japanese Patent Application No. 2004-88339 filed on Mar. 25, 2004 including the specification, claims, drawings and abstract is incorporated herein by reference in its entirety.

1. An optical disk with multi-layered structure provided with at least two recording layers, in which a track is formed in each recording layer;
wherein the said track is formed in such a way that the recording layer has different amount of eccentricity of said track from each other.

2. An optical disk with multi-layered structure provided with at least two recording layers, in which a track is formed in each recording layer;
wherein in that said track is formed in such a way that amplitude of a push-pull signal, which is obtained based on a reflected light from the track, differs in each recording layer.

3. An optical disk with multi-layered structure provided with at least two recording layers, in which a groove is formed in each recording layer and said groove is wobbled in radial direction with predetermined cycle;
wherein said groove is in a state where a high frequency signal with shorter cycle than said predetermined cycle is superimposed and wobbled, and said cycle of the high frequency signal superimposed is different from each other in each recording layer.

4. A method for identifying recording layer, which identifies a recording layer of an optical disk with multi-layered structure provided with at least two recording layers, in which a track is formed in each recording layer; wherein the said track is formed in such a way that the recording layer has different amount of eccentricity of said track from each other,
said method identifying the recording layer by detecting an amount of eccentricity set to a track of said each recording layer.

5. A method for identifying recording layer, which identifies an optical disk with multi-layered structure provided with at least two recording layers, in which a track is formed in each recording layer; wherein said track is formed in such away that amplitude of a push-pull signal, which is obtained based on a reflected light from the track, differs in each recording layer,
said method identifying the recording layer by detecting amplitude of a push-pull signal obtained on the basis of a reflected light from a track of said each recording layer.

6. A method for identifying recording layer, which identifies an optical disk with multi-layered structure provided with at least two recording layers, in which a groove is formed in each recording layer and said groove is wobbled in radial direction with predetermined cycle; wherein said groove is in a state where a high frequency signal with shorter cycle than said predetermined cycle is superimposed and wobbled, and said cycle of the high frequency signal superimposed is different from each other in each recording layer,
said method identifying the recording layer by detecting a high frequency signal superimposed on a wobble of a groove of said each recording layer.
